(19) United States
(12) Patent Application Publication
(10) Pub. No.: US 2025/0333591 A1
(43) Pub. Date: Oct. 30, 2025

(54) RESIN COMPOSITION FOR COOLANT TRANSPORT TUBE FOR VEHICLES AND COOLANT TRANSPORT TUBE FOR VEHICLES

(71) Applicant: Sumitomo Riko Company Limited, Aichi (JP)

(72) Inventors: Masashi OKAHISA, Aichi (JP); Koji Mizutani, Aichi (JP)

(73) Assignee: Sumitomo Riko Company Limited, Aichi (JP)

(21) Appl. No.: 19/263,443

(22) Filed: Jul. 8, 2025

Related U.S. Application Data
(63) Continuation of application No. PCT/JP2024/006488, filed on Feb. 22, 2024.

(30) Foreign Application Priority Data
Mar. 16, 2023 (JP) 2023-041771

(51) Int. Cl. C08L 53/00

(52) U.S. Cl. CPC C08L 53/00; C08L 2203/18

(57) ABSTRACT

Provided are: a resin composition for a coolant transport tube for vehicles, the resin composition making it possible to ensure smoothness through low-temperature extrusion and to ensure physical properties; and a coolant transport tube for vehicles. The resin composition for a coolant transport tube for vehicles comprises the following (A) and (B), the contents of the (A) and the (B) being 75-99 mass % and 1-25 mass %, respectively, with respect to the polymer components, which are taken as 100 mass %. The coolant transport tube for vehicles is formed from the resin composition for a coolant transport tube for vehicles. (A): a propylene/α-olefin block copolymer having a melt flow rate, as determined at 230° C. and a load of 2.16 kg, of 0.2-1.5 g/10 min (B): a propylene homopolymer having a melt flow rate, as determined at 230° C. and a load of 2.16 kg, of 2-50 g/10 min

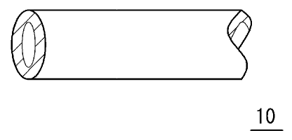

### CROSS-REFERENCE TO RELATED APPLICATION

The present application is a continuation of PCT/JP2024/006488, filed on Feb. 22, 2024, and is related to and claims priority from Japanese Patent Application No. 2023-041771 filed on Mar. 16, 2023. The entire contents of the aforementioned application are hereby incorporated by reference herein.

### TECHNICAL FIELD

The disclosure relates to a resin composition for a coolant transport tube for vehicle and a coolant transport tube for vehicle, and more particularly relates to a resin composition for a coolant transport tube for vehicle and a coolant transport tube for vehicle suitable as a tube for transporting the coolant in a cooling system of an automobile or the like.

### BACKGROUND TECHNOLOGY

There are coolant transport tubes as tubes for transporting a coolant in cooling systems of gasoline vehicles and electric vehicles. For coolant transport tubes, polyamide resin is often adopted from the viewpoint of heat resistance. In recent years, polypropylene-based resin, which is advantageous in terms of cost, has been considered as a material for coolant transport tubes.

### RELATED ART LITERATURES

### Patent Literatures

Patent Literature 1: Japanese Patent Application Laid-Open No. 2012-091730
Patent Literature 2: Japanese Patent Application Laid-Open No. 2006-194318

Coolant transport tubes are long and have many corner sections in piping. Therefore, the flow resistance is large. If the smoothness of the tube inner surface is low, stress may be applied locally, potentially causing cracks. In addition, if the extrusion temperature of the tube is low, the smoothness of the tube inner surface tends to decrease. On the other hand, if the extrusion temperature of the tube is set high, the physical properties of the tube tend to decrease.

The disclosure provides a resin composition for a coolant transport tube for vehicle and a coolant transport tube for vehicle that can ensure smoothness in low-temperature extrusion and ensure physical properties.

### SUMMARY

A resin composition for a coolant transport tube for vehicle according to the disclosure contains the following (A) and (B), in which in 100 mass % of a polymer component, the (A) is 75 mass % or more and 99 mass % or less, and the (B) is 1 mass % or more and 25 mass % or less.
(A) A propylene-α-olefin block copolymer with a melt flow rate of 0.2 g/10 min or more and 1.5 g/10 min or less as measured at 230° C. under a load of 2.16 kg
(B) A propylene homopolymer with a melt flow rate of 2 g/10 min or more and 50 g/10 min or less as measured at 230° C. under a load of 2.16 kg

A difference in melt flow rate as measured at 230° C. under a load of 2.16 kg between the (A) and the (B) may be 5 g/10 min or more. The melt flow rate of the (B) as measured at 230° C. under a load of 2.16 kg may be 10 g/10 min or more and 50 g/10 min or less. In 100 mass % of the polymer components, the (A) may be 90 mass % or more and 97 mass % or less, and the (B) may be 3 mass % or more and 10 mass % or less. The (A) may be an ethylene-propylene block copolymer.

In addition, a coolant transport tube for vehicle according to the disclosure includes the above-mentioned resin composition for the coolant transport tube for vehicle.

The (B) may exist more in an outer part than in an inner part in a radial direction of the coolant transport tube for vehicle.

(1) A resin composition for a coolant transport tube for vehicle according to the disclosure contains the following (A) and (B), in which in 100 mass % of a polymer component, the (A) is 75 mass % or more and 99 mass % or less, and the (B) is 1 mass % or more and 25 mass % or less.
(A) A propylene-α-olefin block copolymer with a melt flow rate of 0.2 g/10 min or more and 1.5 g/10 min or less as measured at 230° C. under a load of 2.16 kg
(B) A propylene homopolymer with a melt flow rate of 2 g/10 min or more and 50 g/10 min or less as measured at 230° C. under a load of 2.16 kg

(2) In (1) above, a difference in melt flow rate as measured at 230° C. under a load of 2.16 kg between the (A) and the (B) may be 5 g/10 min or more.

(3) In (1) or (2) above, the melt flow rate of the (B) as measured at 230° C. under a load of 2.16 kg may be 10 g/10 min or more and 50 g/10 min or less.

(4) In any one of (1) to (3) above, in 100 mass % of the polymer component, the (A) may be 90 mass % or more and 97 mass % or less, and the (B) may be 3 mass % or more and 10 mass % or less.

(5) In any one of (1) to (4) above, the (A) may be an ethylene-propylene block copolymer.

(6) A coolant transport tube for vehicle according to the disclosure includes the resin composition for the coolant transport tube for vehicle according to any one of (1) to (5) above.

(7) In (6) above, the (B) may exist more in an outer part than in an inner part in a radial direction of the coolant transport tube for vehicle.

The resin composition for a coolant transport tube for vehicle according to the disclosure, as described above, can ensure both smoothness in low-temperature extrusion and physical properties by mixing high-viscosity block polypropylene and low-viscosity homopolypropylene in a specific ratio. This can achieve both the physical properties of the tube and the smoothness of the tube inner surface.

Here, when the difference in melt flow rate measured at 230° C. under a load of 2.16 kg between the (A) and the (B) is 5 g/10 min or more, the (B) tends to appear on the tube surface, which improves the smoothness of the tube inner surface.

Furthermore, when the melt flow rate of the (B) measured at 230° C. under a load of 2.16 kg is 10 g/10 min or more and 50 g/10 min or less, the resin composition excels in the effect of improving smoothness in low-temperature extrusion.

Furthermore, when the (A) is 90 mass % or more and 97 mass % or less, and the (B) is 3 mass % or more and 10 mass % or less in 100 mass % of the polymer component, the effect of improving smoothness in low-temperature extrusion and the physical properties can both be achieved at a high level.

Furthermore, when the (A) is an ethylene-propylene block copolymer, the resin composition excels in the effect of achieving both the physical properties of the tube and the smoothness of the tube inner surface.

Furthermore, the coolant transport tube for vehicle according to the disclosure includes the above-mentioned resin composition for the coolant transport tube for vehicle. Therefore, the smoothness in low-temperature extrusion and the physical properties can be ensured. This makes it possible to achieve both the physical properties of the tube and the smoothness of the tube inner surface. In addition, the coolant transport tube is long and has many corner sections in piping. Therefore, the coolant transport tube may excel in bending processability.

Furthermore, when (B) exists more in the outer part than in the inner part in the radial direction of the coolant transport tube for vehicle, the coolant transport tube excels in the effect of improving the smoothness of the tube inner surface.

### BRIEF DESCRIPTION OF DRAWINGS

FIGURE is a configuration diagram showing a coolant transport tube for vehicle according to an embodiment of the disclosure.

### DESCRIPTION OF EMBODIMENTS

A resin composition for a coolant transport tube for vehicle and a coolant transport tube for vehicle according to the disclosure will be described in detail.

A resin composition for a coolant transport tube for vehicle according to the disclosure (hereinafter, may be referred to as the resin composition) contains the following (A) and (B), wherein in 100 mass % of a polymer component, the (A) is 75 mass % or more and 99 mass % or less, and the (B) is 1 mass % or more and 25 mass % or less.
(A) A propylene-α-olefin block copolymer (hereinafter, may be referred to as block polypropylene) having a melt flow rate measured at 230° C. under a load of 2.16 kg of 0.2 g/10 min or more and 1.5 g/10 min or less.
(B) A propylene homopolymer (hereinafter, may be referred to as homopolypropylene) having a melt flow rate measured at 230° C. under a load of 2.16 kg of 2 g/10 min or more and 50 g/10 min or less.

The resin composition, as described above, can ensure smoothness in low-temperature extrusion and ensure physical properties by mixing high-viscosity block polypropylene and low-viscosity homopolypropylene in a specific ratio. This makes it possible to achieve both the physical properties of the tube and the smoothness of the tube inner surface. Low-temperature extrusion refers to performing extrusion at a temperature of 255° C. or lower, preferably in a temperature range of 190° C. to 255° C.

The block polypropylene of (A) exhibits a specific MFR. If the MFR of the block polypropylene of (A) exceeds 1.5 g/10 min, physical properties cannot be ensured. Heat resistance also decreases. If the MFR of the block polypropylene of (A) is less than 0.2 g/10 min, flowability during extrusion cannot be ensured. By setting the MFR of the block polypropylene of (A) to 0.2 g/10 min or more and 1.5 g/10 min or less, physical properties and flowability can be ensured. Also, excellent heat resistance can be achieved. The MFR of the block polypropylene of (A) is more preferably 0.3 g/10 min or more and 1.4 g/10 min or less, even more preferably 0.3 g/10 min or more and 1.2 g/10 min or less, and particularly preferably 0.3 g/10 min or more and 1.0 g/10 min or less. The MFR is measured in accordance with JIS K 7210:1999 under conditions of 230° C. and a load of 2.16 kg.

The block polypropylene of (A) is a propylene-α-olefin block copolymer. The propylene-α-olefin block copolymer is a block copolymer having at least a block formed by continuous propylene monomers and a block formed by continuous α-olefin monomers. The propylene-α-olefin block copolymer is not limited to the above, and may be an alloy (mixture) having a sea-island structure in which a polypropylene component such as a propylene homopolymer forms a sea phase, and a polyethylene component and/or an ethylene-based rubber component forms an island phase. The propylene-α-olefin block copolymer is a concept that includes such an alloy.

Examples of α-olefin include ethylene, 1-butene, 1-hexene, 4-methyl-1-pentene, 1-octene, etc. Among these, ethylene, 1-butene, and 1-hexene are preferable, and ethylene is particularly preferable. When the block polypropylene of (A) is an ethylene-propylene block copolymer, it excels in the effect of achieving both the physical properties of the tube and the smoothness of the tube inner surface.

Examples of the polyethylene component include ethylene homopolymer, ethylene-vinyl acetate copolymer, ethylene-acrylic acid copolymer, ethylene-methacrylic acid copolymer, and ethylene-based copolymer such as copolymer of ethylene and α-olefin (ethylene-propylene copolymer, ethylene-butene copolymer, ethylene-octene copolymer). Examples of the ethylene-based rubber component include ethylene-propylene-diene terpolymer (EPDM), ethylene-propylene copolymer (EPR), ethylene-butene copolymer (EBR), ethylene-octene copolymer (EOR), etc. The content ratio of the polyethylene component and/or the ethylene-based rubber component to the entire alloy (mixture) is preferably 1 mass % to 49 mass %, and more preferably 2.5 mass % to 20 mass %.

The homopolypropylene of (B) exhibits a specific MFR. If the MFR of the homopolypropylene of (B) exceeds 50 g/10 min, the degradation of physical properties becomes significant. If the MFR of the homopolypropylene of (B) is less than 2 g/10 min, the effect of improving the smoothness of the tube inner surface is low. By setting the MFR of the homopolypropylene of (B) to 2 g/10 min or more and 50 g/10 min or less, it is possible to ensure the effect of improving the physical properties of the tube and the smoothness of the tube inner surface. The MFR of the homopolypropylene of (B) is more preferably 5 g/10 min or more and 50 g/10 min or less, and even more preferably 10 g/10 min or more and 50 g/10 min or less. When the MFR of the homopolypropylene of (B) is 10 g/10 min or more and 50 g/10 min or less, it excels in the effect of improving smoothness in low-temperature extrusion. The MFR is measured in accordance with JIS K 7210:1999 under conditions of 230° C. and a load of 2.16 kg.

It is preferable that there is a large difference in MFR between the block polypropylene of (A) and the homopolypropylene of (B). With a large difference in MFR between the block polypropylene of (A) and the homopolypropylene of (B), the homopolypropylene of (B) tends to appear on the tube surface, which improves the smoothness of the tube inner surface. From this viewpoint, the difference in MFR between the block polypropylene of (A) and the homopolypropylene of (B) is preferably 5 g/10 min or more, more preferably 10 g/10 min or more, and even more preferably 15 g/10 min or more. On the other hand, the upper limit of the difference in MFR between the block polypropylene of (A) and the homopolypropylene of (B) is not particularly limited, but is preferably 50 g/10 min or less, and more preferably 45 g/10 min or less.

In 100 mass % of the polymer component, the block polypropylene of (A) is 75 mass % or more and 99 mass % or less, and the homopolypropylene of (B) is 1 mass % or more and 25 mass % or less. If the block polypropylene of (A) is less than 75 mass %, the physical properties cannot be ensured. If the block polypropylene of (A) exceeds 99 mass %, the flowability during extrusion cannot be ensured. Additionally, the smoothness of the tube inner surface decreases. When the ratio of the block polypropylene of (A) and the homopolypropylene of (B) is within the above range, the physical properties and flowability during extrusion can be ensured, and the effect of improving the smoothness of the tube inner surface can be ensured. Also, from this viewpoint, the block polypropylene of (A), in 100 mass % of the polymer component, is more preferably 85 mass % or more and 97 mass % or less, and even more preferably 90 mass % or more and 97 mass % or less. In addition, the homopolypropylene of (B), in 100 mass % of the polymer component, is more preferably 3 mass % or more and 15 mass % or less, and even more preferably 3 mass % or more and 10 mass % or less. Then, when the block polypropylene of (A) is 90 mass % or more and 97 mass % or less and the homopolypropylene of (B) is 3 mass % or more and 10 mass % or less, in 100 mass % of the polymer component, the effect of improving the smoothness in low-temperature extrusion and the physical properties can both be achieved at a high level.

The resin composition may contain other resin components in addition to (A) and (B) in a range where the effect of the disclosure is not impaired. The other resin components may include modified resins that make these components compatible. Examples of such modified resins include acid-modified or carboxy-modified polypropylene. The content of the modified resins is not particularly limited, but is 0.5 parts by mass to 10 parts by mass with respect to 100 parts by mass of the block polypropylene of (A), and preferably 0.5 parts by mass to 5 parts by mass.

Examples of the acid or its derivative in the acid-modified material include unsaturated carboxylic acid and its derivative. Examples of the unsaturated carboxylic acid include maleic acid, fumaric acid, acrylic acid, methacrylic acid, etc. Examples of the derivative of unsaturated carboxylic acid include acid anhydride of unsaturated carboxylic acid, ester compound, amide compound, imide compound, metal salt, etc.

The resin composition may contain other components in addition to (A) and (B) in a range where the effect of the disclosure is not impaired. Examples of the other components include filler, weathering stabilizer, lubricant, pigment, dye, antistatic agent, plasticizer, reinforcing agent, antioxidant, etc.

Examples of the filler include inorganic fillers such as talc, silica, mica, kaolin, calcium carbonate, potassium titanate, apatite, mica, etc. These may be used alone or in combination of two or more. Among these, talc is preferable from the viewpoint of extrusion processability, reinforcement properties, etc.

The content of the filler is not particularly limited, but is 1 part by mass to 100 parts by mass with respect to 100 parts by mass of the block polypropylene of (A), and preferably 10 parts by mass to 70 parts by mass, from the viewpoint of strength.

Examples of the antioxidant include phenolic antioxidant, amine-based antioxidant, imidazole-based antioxidant, phosphoric acid-based antioxidant, etc. The antioxidant may be composed of only one of these or may be composed of two or more. Among these, phenolic antioxidant is preferable from the viewpoint of superior heat resistance. Furthermore, among phenolic antioxidants, hindered phenolic antioxidant is particularly preferable from the viewpoint of heat resistance.

The content of the antioxidant is not particularly limited, but is 0.05 parts by mass to 1.0 parts by mass with respect to 100 parts by mass of the block polypropylene of (A), and preferably 0.1 parts by mass to 1.0 parts by mass.

According to the resin composition with the above configuration, the smoothness in low-temperature extrusion and the physical properties can both be ensured by mixing high-viscosity block polypropylene and low-viscosity homopolypropylene in a specific ratio. This makes it possible to achieve both the physical properties of the tube and the smoothness of the tube inner surface.

A coolant transport tube for vehicle according to the disclosure (hereinafter, may be referred to as the resin tube) can be obtained from the resin composition. The resin tube is suitably implemented as a single-layer structure resin tube 10 as shown in FIGURE, for example. Additionally, if necessary, the resin tube may be made into a multi-layer structure resin tube by further laminating other resin layers or reinforcing fiber layers.

From the viewpoint of application, the resin tube preferably has an inner diameter in a range of 2.5 mm to 30 mm, particularly 4 mm to 25 mm, and a thickness in a range of 0.5 mm to 5.0 mm, particularly 0.75 mm to 4.0 mm.

The resin tube is used, for example, for coolant piping in an automobile, and specifically, the resin tube is suitably used for radiator hoses, heater hoses, air conditioner hoses, etc., or for cooling tubes for battery packs in an electric vehicle or fuel cell vehicle.

The resin tube can be manufactured by melt extrusion molding the resin composition into a tubular shape. The resin composition can be obtained by mixing and kneading (A) and (B), and components mixed as needed.

The kneading process of the resin composition may be performed using, for example, a twin-screw kneading extruder. The kneading temperature is preferably 190° C. to 230° C. The kneading time is preferably 0.01 minutes to 10 minutes.

The extrusion process of the resin composition may be performed using, for example, a twin-screw kneading extruder. From the viewpoint of improving the inner surface smoothness of the tube in low-temperature extrusion, the extrusion temperature is preferably 190° C. to 255° C.

In the resin tube, it is preferable that the homopolypropylene of (B) appears on the tube surface, which results in the presence of more homopolypropylene of (B) in the outer part than in the inner part in the radial direction of the tube. By using the resin composition, the homopolypropylene of (B) can be distributed unevenly as described above in the resin tube. And, such a configuration excels in the effect of improving the inner surface smoothness of the tube. The outer part in the radial direction of the tube refers to the portion located at or near the surface in the radial direction of the tube, and represents the outer circumferential surface or inner circumferential surface of the tube, or a portion near the outer circumferential surface or inner circumferential surface of the tube. The inner part in the radial direction of the tube refers to the portion located inward in the radial direction relative to the outer part, and is, for example, a portion including the central part in the radial direction, etc.

Although the embodiments of the disclosure have been described above, the disclosure is not limited to the above embodiments in any way, and various modifications are possible within the scope that does not deviate from the spirit of the disclosure.

### EXAMPLES

The disclosure will be described in detail below using examples and comparative examples.

### Examples 1 to 6, Comparative Examples 1 to 3

The components were mixed in the mixing ratios (parts by mass) shown in the table, and kneaded for 5 minutes at 200° C. using a twin-screw kneading extruder (“TEM-18SS” manufactured by Toshiba Machine) to obtain a kneaded material. Next, the kneaded material was pelletized, and the pellets were melt extrusion molded into a tube shape at 250° C. using a melt extrusion molding machine (“GT-40” manufactured by Research Laboratory of Plastics Technology Co., Ltd.) equipped with a cylindrical die, to obtain a resin tube with an inner diameter of 18 mm and an outer diameter of 20 mm.

The materials used are as follows.
(A) Propylene-α-olefin block copolymer
   Block PP<1>: Prime polymer made “E-701G”, MFR 0.5 g/10 min
   Block PP<2>: Prime polymer made “E-702 MG”, MFR 1.4 g/10 min
(B) Propylene homopolymer
   Homo PP<1>: Prime polymer made “E200GP”, MFR 2.0 g/10 min
   Homo PP<2>: Prime polymer made “J106MG”, MFR 16 g/10 min
   Homo PP<3>: Prime polymer made “J108M”, MFR 45 g/10 min
(B′) Propylene homopolymer
   Homo PP<4>: Prime polymer made “E200GPL”, MFR 1.4 g/10 min
   Homo PP<5>: Lyondellbasell made “C14EP348U”, MFR 70 g/10 min

For the obtained resin tubes, evaluation of each property was conducted according to the following criteria. The results are shown together in Table 1 below.

### <Smoothness (Low-Temperature Extrusion)>

The obtained resin tube was half-cut, and measurements were taken at three locations, the central part and near the left and right cross-sections, using a caliper. Compared to the target thickness (1.00 mm), those with any of the three locations deviating by more than 0.05 mm were rated as “x”, those with all three locations within 0.05 mm and any location exactly at 0.05 mm were rated as “o”, and those with all three locations less than 0.05 mm were rated as “⊚”.

### <Physical Properties>

After heat treatment of the resin tube at 160° C. for 1 hour, the resin tube was half-cut and punched into strip-shaped samples with a width of 10 mm and a length of 15 cm. The elongation at break [Eb] of the obtained strip-shaped samples was measured using a tensile testing machine (AGS-X, manufactured by Shimadzu Corporation) in accordance with JIS K 6251. Those with elongation at break of 350% or more were rated as “⊚”, those with elongation at break of 300% or more were rated as “o”, and those with less than 300% were rated as “x”.

TABLE 1

| | | MFR | Example | | | | | | Comparative Example | | |
|---|---|---|---|---|---|---|---|---|---|---|---|
| | | (g/10 min) | 1 | 2 | 3 | 4 | 5 | 6 | 1 | 2 | 3 |
| (A) | Block | 0.5 | 95 | 95 | 95 | 80 | 98 | — | 95 | 95 | 70 |
| | PP<1> | | | | | | | | | | |
| | Block | 1.4 | — | — | — | — | — | 95 | — | — | — |
| | PP<2> | | | | | | | | | | |
| (B) | Homo | 2.0 | 5 | — | — | — | — | — | — | — | — |
| | PP<1> | | | | | | | | | | |
| | Homo | 16 | — | 5 | — | 20 | 2 | 5 | — | — | 30 |
| | PP<2> | | | | | | | | | | |
| | Homo | 45 | — | — | 5 | — | — | — | — | — | — |
| | PP<3> | | | | | | | | | | |
| (B′) | Homo | 1.4 | — | — | — | — | — | — | 5 | — | — |
| | PP<4> | | | | | | | | | | |
| | Homo | 70 | — | — | — | — | — | — | — | 5 | — |
| | PP<5> | | | | | | | | | | |

| | | | | | | | | | |
|---|---|---|---|---|---|---|---|---|---|
| Smoothness (low- | ◯ | ⊚ | ⊚ | ⊚ | ◯ | ⊚ | X | ⊚ | ⊚ |
| temperature extrusion) | | | | | | | | | |
| Central part (mm) | 1.01 | 0.99 | 0.99 | 1.01 | 1.01 | 0.99 | 1.02 | 1.00 | 1.02 |
| Right end part (mm) | 1.05 | 1.03 | 1.02 | 1.01 | 1.04 | 1.02 | 1.07 | 1.02 | 1.01 |
| Left end part (mm) | 0.97 | 0.99 | 0.98 | 0.98 | 0.95 | 0.97 | 0.96 | 0.97 | 1.00 |
| Physical properties | ⊚ | ⊚ | ⊚ | ◯ | ⊚ | ⊚ | ⊚ | X | X |
| Elongation at break | 410 | 450 | 380 | 310 | 430 | 400 | 430 | 150 | 270 |
| [Eb] (%) | | | | | | | | | |

In Comparative Example 1, since a propylene homopolymer with an MFR of 1.4 g/10 min is used, the smoothness of the tube inner surface is degraded in low-temperature extrusion. In Comparative Example 2, since a propylene homopolymer with an MFR of 70 g/10 min is used, the elongation at break is small, and the physical properties are degraded. In Comparative Example 3, although a propylene homopolymer with an MFR of 16 g/10 min is used, an excessive amount is mixed, so the elongation at break is small and the physical properties are degraded.

In contrast thereto, the examples satisfy the physical properties with sufficient elongation at break. Additionally, the examples excel in smoothness of the tube inner surface even in low-temperature extrusion. From the above, it was confirmed that by using a resin composition containing (A) a propylene-α-olefin block copolymer with a melt flow rate of 0.2 g/10 min or more and 1.5 g/10 min or less as measured at 230° C. under a load of 2.16 kg, and (B) a propylene homopolymer with a melt flow rate of 2 g/10 min or more and 50 g/10 min or less as measured at 230° C. under a load of 2.16 kg, wherein in 100 mass % of the polymer component, (A) is 75 mass % or more and 99 mass % or less, and (B) is 1 mass % or more and 25 mass % or less, the smoothness in low-temperature extrusion and the physical properties can be ensured.

In the comparison among the examples, from Examples 1 to 3, it is understood that when the difference in MFR between (A) and (B) is 5 g/10 min or more, the smoothness of the tube inner surface is further improved. Additionally, from Examples 1 to 3, it is understood that when the MFR of (B) is 10 g/10 min or more and 50 g/10 min or less, the effect of improving the smoothness in low-temperature extrusion is more excellent. Furthermore, from Examples 2, 4, and 5, it is understood that when (A) is 90 mass % or more and 97 mass % or less, and (B) is 3 mass % or more and 10 mass % or less in 100 mass % of the polymer component, the effect of improving the smoothness in low-temperature extrusion and the physical properties can both be achieved at a high level.

The embodiments and examples of the disclosure have been described above, but the disclosure is not limited to the above embodiments and examples, and various changes are possible within the scope that does not deviate from the spirit of the disclosure.

1. A resin composition for a coolant transport tube for vehicle, comprising following (A) and (B), wherein in 100 mass % of a polymer component, the (A) is 75 mass % or more and 99 mass % or less, and the (B) is 1 mass % or more and 25 mass % or less,
(A) a propylene-α-olefin block copolymer with a melt flow rate of 0.2 g/10 min or more and 1.5 g/10 min or less as measured at 230° C. under a load of 2.16 kg,
(B) a propylene homopolymer with a melt flow rate of 2 g/10 min or more and 50 g/10 min or less as measured at 230° C. under a load of 2.16 kg.

2. The resin composition for the coolant transport tube for vehicle according to claim 1, wherein the (A) and the (B) have a difference in melt flow rate of 5 g/10 min or more as measured at 230° C. under a load of 2.16 kg.

3. The resin composition for the coolant transport tube for vehicle according to claim 1, wherein the melt flow rate of the (B) as measured at 230° C. under a load of 2.16 kg is 10 g/10 min or more and 50 g/10 min or less.

4. The resin composition for the coolant transport tube for vehicle according to claim 1, wherein in 100 mass % of the polymer component, the (A) is 90 mass % or more and 97 mass % or less, and the (B) is 3 mass % or more and 10 mass % or less.

5. The resin composition for the coolant transport tube for vehicle according to claim 1, wherein the (A) is an ethylene-propylene block copolymer.

6. A coolant transport tube for vehicle, comprising the resin composition for the coolant transport tube for vehicle according to claim 1.

7. The coolant transport tube for vehicle according to claim 6, wherein the (B) exists more in an outer part than in an inner part in a radial direction of the coolant transport tube for vehicle.
